(19) United States
(12) Patent Application Publication
(10) Pub. No.: US 2007/0155927 A1
(43) Pub. Date: Jul. 5, 2007

(54) Paste resins for aqueous paints

(75) Inventors: Gerald Hobisch, Graz (AT); Peter Morre, Graz (AT); Willibald Paar, Graz (AT); Franz Kurzmann, St. Georgen (AT)

Correspondence Address: CONNOLLY BOVE LODGE & HUTZ, LLP, P O BOX 2207, WILMINGTON, DE, 19899, US

(73) Assignee: Cytec Surface Specialties Austria GmbH, Werndorf (AT)

(21) Appl. No.: 11/647,051

(22) Filed: Dec. 28, 2006

(30) Foreign Application Priority Data
Dec. 30, 2005 (EP) 05028769.7

(51) Int. Cl. C08F 120/00

(52) U.S. Cl. 526/303.1; 526/319

(57) ABSTRACT

Copolymers ABCDE obtainable by polymerising a monomer mixture comprising olefinically unsaturated monomers A having at least one urethane group —O—CO—NH—, basic (meth)acrylic monomers B which comprise at least one tertiary amino group, alkyl(meth)acrylates C, wherein the alkyl residue is linear, branched, or cyclic, and may have from 1 to 20 carbon atoms, olefinically unsaturated compounds D having at least one hydroxyl group in the molecule, preferably hydroxyalkyl(meth)acrylates, olefinically unsaturated compounds E having none of the functional groups of monomers A and C, and no acid groups, which are neutralised to an extent of from 10% to 100% and dispersed in water, and a method of use thereof as paste resins

This invention relates to paste resins for aqueous paints.

In the production of paints, paste resins are used to prepare pigment pastes or concentrates which can be easily metered, and which are storage stable compositions with no or virtually no reagglomeration of pigment particles. It is desirable to use the least amount possible of a carrier resin to prepare such pigment formulations; the mass ratio of pigments to resin is usually referred to as pigment binding capacity. When preparing such pigment pastes, solid pigments are milled together with a resin or a mixture of resins, optionally together with fillers and further additives, in so-called ball mills. Resins which can be used in such applications must be able to withstand these severe shear conditions, and they must have a sufficient affinity to the pigment particles to be able to disperse them effectively. As pigments may have largely different chemical properties, such affinity has to be independent of the chemical nature of the pigments used. The particle size and size distribution of the pigments has an impact on the colour shade and hue, his distribution shall therefore be conserved in the preparation and storage of a pigment paste.

It is therefore the purpose of this invention to provide resins having a high pigment binding capacity, a broad compatibility to pigments, and optionally, fillers, which resins may be used to prepare water-reducible pigment paste compositions, especially those that can be used in combination with basic binder resins which are rendered water-reducible by neutralisation with acids.

It has been found that certain polymers on the basis of (meth)acrylic compounds and further olefinically unsaturated monomers are well-suited as paste resins for water-reducible pigment paste compositions.

An object of this invention are therefore copolymers ABCDE which are obtained by polymerising a monomer mixture comprising mass fractions of
from 10% to 95% of olefinically unsaturated monomers A having at least one urethane group -0-CO-NH-,
from 0% to 50% of basic (meth)acrylic monomers B which comprise at least one tertiary amino group,
from 2.5% to 60% of alkyl(meth)acrylates C, wherein the alkyl residue is linear, branched, or cyclic, and may have from 1 to 20 carbon atoms
from 0% to 20% of olefinically unsaturated compounds D having at least one hydroxyl group in the molecule, preferably hydroxyalkyl(meth)acrylates,
from 0% to 20% of olefinically unsaturated compounds E having none of thfe functional groups of monomers A and C, and no acid groups.

Mass fractions are the ratios of the mass of a specific constituent to the sum of the masses of all constituents, the values thereof are to be chosen in a way that the sum of all mass fractions equals 100%.

The copolymers ABCDE are neutralised with an acid G to achieve a degree of neutralisation of between 10% and 100%, preferably of between 30% and 60%, to make the copolymer water-dilutable. A degree of neutralisation of 100% means that the amount of acid is sufficient to convert 100% of the amino groups to the corresponding ammonium cations. A “water-dilutable” resin is one which forms single phase mixtures with water at room temperature (23° C.) in a binary mixture with a mass fraction of resin of from 1% to 40%.

A further object of the invention is a process to prepare the copolymers ABCDE by radically initiated copolymerisation, in a solvent, or in bulk. For the latter process variant, it is preferred to employ a compound as a solvent which may be incorporated into the polymer by a polymer analogue reaction, or by copolymerisation when the other monomers are (nearly) completely consumed.

Other objects of the invention are a method of use of the copolymers ABCDE in the preparation of pigment paste compositions, and a method of use of such pigment paste compositions in the preparation of water-borne paints.

In a preferred embodiment, the mass fraction of monomers A is from 15% to 80%, and especially preferred, from 25% to 70%. Preferably, the mass fraction of monomers B is from 2.5% to 40%, and especially preferred, from 5% to 35%. In other preferred embodiments, the mass fraction of C is from 5% to 50%, and especially preferred, from 10% to 40%, the mass fraction of D is from 2.5% to 15%, and especially preferred, from 5% to 10%, and the mass fraction of E is from 2.5% to 15%, and especially preferred, from 5% to 10%.

The copolymer ABCDE preferably has a number-average molar mass of from 2 kg/mol to 20 kg/mol, corresponding to a Staudinger index of from 8 cm³/g to 30 cm³/g, measured in chloroform as solvent at 23° C. It preferably has a hydroxyl number of from 0 mg/g to 150 mg/g, more preferably of from 20 mg/g to 70 mg/g, an amine number of from 20 mg/g to 150 mg/g, more preferably of from 50 mg/g to 120 mg/g. After neutralisation with acid, its pH in aqueous solution is preferably between 2.0 and 7.5, more preferably between 4.0 and 6.5.

The physical quantity formerly referred to as “limiting viscosity number”, properly named “Staudinger-Index” J_{g} according to DIN 1342, part 2.4, is the limiting value of the Staudinger function Jᵥ for decreasing concentration and shear gradient, wherein Jᵥ stands for the relative change in viscosity divided by the mass concentration β_{B}=m_{B}/V of the solute B (having a mass m_{B} of the solute in a volume V of the solution), viz., Jᵥ=(η−1)/β_{B}. The relative change in viscosity ηᵣ−1 is calculated as ηᵣ−1=(η−ηₛ)/η_{s,}. The relative viscosity ηᵣ is the ratio of the viscosity η of the solution under consideration, and the viscosity ηₛ of the pure solvent. The physical significance of the Staudinger index is that of a specific hydrodynamic volume of the solvated polymer coils at infinite dilution in the state of rest. The unit generally accepted for J is “cm³/g”; formerly often “dl/g”.

The hydroxyl number is defined according to DIN EN ISO 4629 (DIN 53 240) as the ratio of the mass of potassium hydroxide m_{KOH} having the same number of hydroxyl groups as the sample, and the mass m_{B} of that sample (mass of solids in the sample for solutions or dispersions); the customary unit is “mg/g”.

The amine number is defined, according to DIN 53 176, as the ratio of that mass m_{KOH} of potassium hydroxide that consumes the same amount of acid for neutralisation as the sample under consideration, and the mass m_{B} of that sample, or the mass of solid matter in the sample in the case of solutions or dispersions, the commonly used unit is “mg/g”.

The olefinically unsaturated monomers A are preferably made by reacting a hydroxy functional olefinically unsaturated compound A1, preferably a hydroxyalkyl(meth)-acrylate, with an isocyanate A2 and with compounds A3 which are selected from the group consisting of linear, branched, and cyclic aliphatic alcohols A31 having at least one hydroxyl group and from 2 to 20 carbon atoms, and from compounds A32 having at least one tertiary amino group and at least one further group which is reactive towards isocyanate groups, selected from the group consisting of mercaptan groups, hydroxyl groups, and primary and secondary amino groups. Compounds A3 are only used in the synthesis of monomers A if the isocyanate A2 has more than one isocyanate functional group per molecule.

The olefinically unsaturated compounds A1 preferably have exactly one hydroxyl group per molecule, and from five to ten carbon atoms. Preferred are half esters of dihydric aliphatic linear, branched or cyclic alcohols having from two to six carbon atoms and olefinically unsaturated carboxylic acids having from three to eight carbon atoms, at least one olefinic double bond, and at least one carboxylic acid group. Particularly preferred are hydroxy ethyl(meth)acrylate, the isomers of hydroxypropyl(meth)acrylate, 4-hydroxy-butyl(meth)acrylate, 6-hydroxyhexyl(meth)acrylate, and glycerol mono(meth)acrylate.

Both aliphatic and aromatic isocyanates A2 may be used, which may be monoisocyanates A21 or diisocyanates A22, phenylisocyanate, lauryl isocyanate, and stearyl isocyanate being preferred as monoisocyanates A21, and toluylene diisocyanate, diphenylmethane diisocyanate, tetramethylxylylene diisocyanate, as well as hexamethylene diisocyanate, isophorone diisocyanate, and 1,3-bis-isocyanatocyclohexane are preferred as diisocyanates A22.

The compounds A32 have at least one tertiary amino group and at least one groups which is reactive towards isocyanate groups. Examples of suitable compounds are dimethylamino propylamine, dimethylamino ethylamine, dimethylamino ethanol, diethylamino ethanol and N-methyl-4-hydroxypiperidine.

As suitable basic acrylic monomers B, mention shall be made of N,N-dialkylaminoalkyl(meth)acrylates, such as 2-N,N-dimethylaminoethyl acrylate, 3-N,N-dimethylaminopropyl acrylate, 2-N,N-diethyl-aminoethyl acrylate and 3-N,N-diethylaminopropyl acrylate, N-2-acryloyloxyethyl piperidine, N-2-acryloyloxyethyl N′-methyl piperazine and N-2-acryloyloxyethyl morpholine, as well as the corresponding methacrylic compounds.

The olefinically unsaturated esters C are derived from olefinically unsaturated carboxylic acids C1 and saturated aliphatic linear, branched, or cyclic alcohols C2. As components C1, acrylic acid, methacrylic acid, vinylacetic acid, and crotonic acid are preferred, preferred alcohols C2 are methanol, ethanol, n- and iso-propanol, n-, iso-, sec.- and tert.-butanol, n-hexanol and 2-ethylhexanol, borneol and iso-borneol, as well as tricyclodecanol (“TCD alcohol”).

Compounds D are the same as those mentioned under A1.

As compounds E, it is possible to use olefinically unsaturated ketones or ethers, while special preference is given to vinylaromatic compounds such as styrene, vinyl toluene, alpha-methyl styrene, p-methyl styrene, and vinyl naphthalene.

Polymerisation of the monomers A through E is preferably initiated by radicals, and conducted in a solvent or in a further liquid component F which reacts, under the polymerisation conditions, preferably towards the end of the polymerisation reaction, with at least one of the (remaining) monomers in an addition reaction, such as aliphatic lactones which are added, under ring opening, to hydroxyfunctional monomers, or epoxy compounds such as esters and ethers of glycidyl alcohol with aliphatic carboxylic acids or aliphatic alcohols, or such olefinically unsaturated monomers F′ which are only incorporated in a later stage of the polymerisation reaction when more reactive monomers have been consumed, such as dimethyl maleinate. The condition of being “liquid” is meant to relate to such compounds that are liquid, or soluble in the mixture of monomers such that a liquid mixture is formed, at the reaction temperature of the polymerisation reaction which is preferably between 80° C. and 150° C. Among the aliphatic lactones, mention is made of caprolactone, valerolactone, and butyrolactone, and among the epoxy compounds, of glycidyl esters of neopentanoic or neodecanoic acids, and glycidyl ethers of hexanol and 2-ethylhexanol.

If a solvent is used, this may be removed, in a preferred embodiment, by distillation, and may optionally be replaced by a water-miscible solvent.

Neutralisation of the basic groups of the copolymer by addition of acids such as formic, acetic, or lactic acid, may preferably be effected before addition of water. In another embodiment, it is also possible to add the acids to the water used for dilution. The paste resin, in the aqueously diluted form, has a mass fraction of solids of preferably from 20% to 50%, and its pH is from 3.0 to 7.0.

The paste resin of the invention may be added to pigments, or mixtures of pigments, wherein the mixtures of pigments and paste resin are homogenised in a ball or bead mill at room temperature (23° C.) for from one half hour to five hours. The pigment pastes thus made exhibit excellent storage stability (no change in colour or hue for at least 6 weeks) and high pigment loading (mass fraction of pigment in the paste). They are especially suited to make white, grey, and black colour paste compositions, where predominantly titanium dioxide, carbon black or lamp black are used, optionally admixed with minor quantities of coloured pigments which are mostly organic in nature.

The pigment paste compositions thus obtained exhibit excellent compatibility with paints on the basis of basic binders which are made water dilutable by neutralisation with acids, as shown by assessment of gloss and haze on paint films made with coating compositions comprising the pigment pastes of the present invention.

### EXAMPLES

In these examples, all concentrations measured in “%” (g/hg or cg/g) are mass fractions, calculated by dividing the mass of solute by the mass of the solution.

### Example 1

### Comparative

Paste resins were made from copolymers C1 und C3 according to the examples 1 and 3 of EP 0 260 456 A2. Table 1 shows the monomer composition.

TABLE 1
Masses of monomers in g

| monomer | C1 | C3 |
|---|---|---|
| N-cyclohexyl methacrylamide | | 145 |
| N,N-dimethylaminoethyl methacrylate | | 137 |
| N,N-dimethylaminopropyl methacrylamide | 149 | |
| butyl methacrylate | 93 | |
| 2-ethylhexyl acrylate | 93 | 56 |
| 2-hydroxypropyl methacrylate | 375 | 373 |
| methyl methacrylate | 186 | |
| tert.-butyl acrylate | | 187 |
| styrene | 167 | 166 |

Mixtures of monomers were prepared using the masses of monomers as stated in Table 1, which mixtures were then fed to a charge of mixed solvents (200 g of butyl acetate and 132 g of xylene) at 100° C., over a period of five hours, while at the same time, a solution of 17 g of azobis(isobutyro nitrile) in a mixture of 270 g of butyl acetate and 143 g of xylene was added. The temperature was kept at 100° C. during the reaction. When the monomer feed was completed, further 6 g of azobis(isobutyro nitrile) in a mixture of 90 g of butyl acetate and 48 g of xylene were added. When the polymerisation was finished, the solution was cooled to 60° C. and diluted by addition of a further 448 g of butyl acetate. To the solutions of copolymers C1 and C3 thus obtained, 82 g each of a solution of a partially capped isocyanate was added (a reaction product of 197 g of ethyl acetoacetate and 560 g of ®Desmodur N 3390 which is a solution comprising a mass fraction of 90% of an isocyanate based on 1,6-diisocyanato hexane in a mixture of equal masses of butyl acetate and ®Solvent Naphtha S, a mixture of aromatic hydrocarbons having a boiling temperature range of from 150° C. to 180° C.). After a reaction time of approximately two hours, no more free isocyanate groups could be detected. These resins were adjusted to a pH of 4.5 (measured in an aqueous solution comprising a mass fraction of 10% of resin) by addition of acetic acid, and then diluted with water to a mass fraction of solids of 35%. The resins made are referred to as RC1 and RC3.

### Example 2

### Preparation of Monomers Having a Urethane Structure

2.1 Monomer VP1

130 g of hydroxyethyl methacrylate, dissolved in 130 g of methoxypropyl acetate, were charged to a reactor, and heated to 40° C. 313 g of a solution comprising a mass fraction of 50% of toluylene diisocyanate in methoxypropyl acetate were slowly added, dropwise, at 40° C., and the reaction was continued at this temperature until the theoretical value for the mass fraction of residual isocyanate (NCO) groups of 5.8%, based on the mass of the reaction mixture, was reached. The residual isocyanate groups were then consumed by addition of a solution comprising a mass fraction of 50% of N,N-dimethyl ethanolamine in methoxypropyl acetate, the mass fraction of isocyanate groups remaining having fallen below 0.01%. The basic monomer thus prepared is in the form of a solution in methoxypropyl acetate, with a mass fraction of 50%, and an amine number of 80 mg/g based on the mass of the solution, or of 160 mg/g, based on the mass of the monomer.

2.2 Monomer VP2

116 g of hydroxyethyl acrylate, dissolved in 116 g of methoxypropyl acetate, together with 0.2 g of dibutyltin dilaurate as a catalyst were charged to a reactor, and heated to 60° C. 444.6 g of a solution comprising a mass fraction of 50% of isophorone diusocyanate in methoxypropyl acetate were slowly added, dropwise, at 60° C., and the reaction was continued at this temperature until the theoretical value for the mass fraction of residual isocyanate groups of 6.2%, based on the mass of the reaction mixture, was reached. The residual isocyanate groups were then consumed by addition of a solution comprising a mass fraction of 50% of N,N-diethyl ethanolamine in N-methylpyrrolidone, the mass fraction of isocyanate groups remaining having fallen below 0.01%. The basic monomer thus prepared is in the form of a solution in a mixed solvent, with a mass fraction of 50%, and an amine number of 61.5 mg/g based on the mass of the solution, or of 123 mg/g, based on the mass of the monomer.

2.3 Monomer VP3

116 g of hydroxyethyl acrylate, dissolved in 116 g of methoxypropyl acetate, together with 0.2 g of dibutyltin dilaurate as a catalyst were charged to a reactor, and heated to 60° C. 444.6 g of a solution comprising a mass fraction of 50% of isophorone diisocyanate in methoxypropyl acetate were slowly added, dropwise, at 60° C., and the reaction was continued at this temperature until the theoretical value for the mass fraction of residual isocyanate groups of 6.2%, based on the mass of the reaction mixture, was reached. The residual isocyanate groups were then consumed by addition of a solution comprising a mass fraction of 50% (162 g) of diethylene glycol monobutyl ether in methoxypropyl acetate, the mass fraction of isocyanate groups remaining having fallen below 0.01%. The urethane group-containing monomer thus prepared is in the form of a solution in methoxypropyl acetate, with a mass fraction of 50%, and an amine number of less than 3 mg/g, based on the mass of the monomer.

2.4 Monomer VP4

119 g of phenyl isocyanate were charged to a reactor, and 130 g of hydroxyethyl methacrylate were added slowly to keep the reaction temperature at 40° C., until the mass fraction of residual isocyanate groups had fallen below 0.01%. The amine number of this reaction product is also below 3 mg/g.

### Example 3

### Preparation of Paste Resins

Copolymers were prepared according to the following general procedure: Isopropanol as solvent was charged into a reactor equipped with a stirrer, dropping funnel, and reflux condenser, the reactor was evacuated and flushed with nitrogen. The solvent is then heated to reflux temperature, the monomers (as listed in Table 2) and a solution comprising a mass fraction of 20% of a radical initiator, azobis isobutyronitrile, its mass being 2% of the mass of the monomer mixture, were slowly and continuously fed at the same time, over six hours. The mass fraction of solids formed by the polymerisation reaction in the solution was 60%, in theory. When the feed was completed, temperature was kept at the reflux condition for two further hours, whereafter the mass fraction of solids in the reaction solution was determined to monitor the degree of conversion. When 59% was exceeded, the volatile solvents (isopropanol, methoxypropyl acetate) were removed by distillation under reduced pressure, to leave a residue having a mass fraction of solids of more than 95%. A mixture of water and acid (having a mass fraction of acid of 20%) was added to adjust the pH (as measured on a diluted solution in water with a mass fraction of solids of 10%) to 4.5. Water was then added to form an aqueous dispersion having a mass fraction of solids of 35%. Formic, acetic, and lactic acids were used for neutralisation, see table 2.

TABLE 2
Preparation of Paste Resins

| | | Example | | | | | | | |
|---|---|---|---|---|---|---|---|---|---|
| monomer | | PR1 | | PR2 | | PR3 | | PR4 | |
| A | VP3 | 50 | g | 10 | g | 40 | g | 20 | g |
| | VP4 | 10 | g | | | | | | |
| B | DMAEMA | 20 | g | | | | | 10 | g |
| | VP1 | | | 60 | g | | | 30 | g |
| | VP2 | | | | | 32 | g | | |
| C | iBoMA | | | 10 | g | 5 | g | | |
| | BuA | 7.5 | g | | | 8 | g | 15 | g |
| | 2-EHA | 7.5 | g | 10 | g | 3 | g | 5 | g |
| | LauMA | | | | | | | 5 | g |
| D | HEA | 5 | g | | | | | | |
| | HEMA | | | 5 | g | | | 10 | g |
| | Glyc-mMA | | | | | 10 | g | | |
| E | styrene | | | 5 | g | | | 5 | g |

| | | | | | |
|---|---|---|---|---|---|
| G | formic acid | | X | | |
| | acetic acid | X | | | X |
| | lactic acid | | | X | |

| | | | | | | | | |
|---|---|---|---|---|---|---|---|---|
| OH number | 25 | mg/g | 22 | mg/g | 69 | mg/g | 42 | mg/g |
| amine number | 71 | mg/g | 88 | mg/g | 39 | mg/g | 82 | mg/g |

### Example 4

### Preparation of Pigment Paste Compositions

In the preparation of a pigment paste, a paste resin was diluted with water, pigments were admixed, and the resulting mixture was dispersed for forty minutes in a bead mill using ceramic beads, at a rotation frequency of 2000 min⁻¹. Water was added as portion II to adjust the viscosity to a range of from 1400 mPa·s to 1800 mPa·s. After dispersing, the beads were separated with a sieve, and the pigment paste was deaerated. Viscosity and pigment loading were then determined, as well as the storage stability as measured by any change in viscosity at room temperature (23° C.), and at 40° C. The master composition was as shown in table 3:

TABLE 3
Composition of Pigment Paste

| Portion | Ingredient | mass in g |
|---|---|---|
| I | paste resin* | 142.9 |
| | ®Texanol | 12.5 |
| | ethylene glycol monobutyl ether | 12.5 |
| II | deionised water | 123.5 |
| III | ®special black 4* | 18.25 |
| | ASP 600* | 181.75 |
| IV | ®Surfynol 104 A | 8.75 |
| V | deionised water | as needed |
| | total | 500 (approximately) |

*past resins: having each a mass fraction of solids of 35%
®Texanol: 2,2,4-trimethyl-1,3-pentane diol-monoisobutyrate (Eastman Chemical)
ASP 600: aluminium silicate pigment (Engelhard Corp., Iselin, NJ, USA)
special black 4 (“Spezialschwarz 4”): carbon black, Degussa - Hüls AG
Surfynol 104 A: surfactant, Air Products Chemicals Europe B.V.

In table 4, the viscosities of the pigment paste compositions thus prepared, the amount of water added to adjust to the desired viscosity, and the pigment load (mass fraction of pigment in the pigment paste) are compiled:

TABLE 4
Characteristics of the Pigment Pastes

| | | | | | | | |
|---|---|---|---|---|---|---|---|
| Paste | | P1 | P2 | P3 | P4 | CP1 | CP3 |
| Designation | | | | | | | |
| paste resin | | PR1 | PR2 | PR3 | PR4 | C1 | C3 |
| used | | | | | | | |
| viscosity | in | 1390 | 1610 | 1520 | 1490 | 1560 | 1770 |
| | mPa · s | | | | | | |
| mass of water | in g | — | 8.0 | — | — | — | 12 |
| (portion II) | | | | | | | |
| mass fraction | in cg/g | 40 | 39.4 | 40 | 40 | 35.7 | 35 |
| of pigment | | | | | | | |

In the comparative paste compositions, the basic composition had to be complemented with an additional 60 g of water in portion II to arrive at the viscosity needed for dispersing. Therefore, the pigment load was only about 35%.

### Example 5

### Paint Test

A water-reducible epoxy-modified cationic acrylic resin (®Resydrol VSC 6269w/38 WA, Cytec Surface Specialties Austria GmbH) has been used in the evaluation of paint performance. The binder was first diluted with water, a tin-based catalyst was added, and the mixture was homogenised. Then, the pigment paste was added, and the paint obtained was stirred for one hour. The following paint compositions were used:

TABLE 5
Test Paints

| Portion | ingredient | mass in g |
|---|---|---|
| I | Binder (®Resydrol VSC 6292w/38WA) | 705.9 |
| | deionised water | 1656.8 |
| | catalyst composition* | 23.3 |
| II | pigment paste | 114 |
| | Total | 2500 |
| | mass fraction of solids | 13.44% |
| | mass ratio of pigment to binders | 0.12:1 |

The paints were then applied electrophoretically to a steel sheet (bonder type B 26, Chemetall GmbH), in a wet layer thickness of from 20 μm to 25 μm, the coatings were rinsed with water and dried under an air flow for ten minutes at 80° C. Thereafter, the coating films were cured at 180° C. for twenty minutes, and visually inspected for surface defects after two hours' rest.

The paint films were cured, in a further series of tests, alternatively at 160° C. (insufficient cure) and at the regular temperature of 180° C., to assess the influence of the pigment paste on the curing behaviour. The degree of curing was tested via the solvent resistance (acetone test). 2 ml of acetone were applied with a pipette onto the cured paint film which was then tested by scratching with a fingernail for softening. The time until the paint film could be removed is stated.

The quality and homogeneity of the pigment dispersion was tested with the “L effect test” according to an approved procedure of the German Automotive Industry Association (VDA test 621-188). Sedimentation of pigment during the deposition of electro dip coats on horizontal surfaces is measured in this test.

The following results were found:

TABLE 6
Results

| | Paint | Paint | Paint | Paint | Paint | Paint |
|---|---|---|---|---|---|---|
| | 1 | 2 | 3 | 4 | 5 | 6 |
| Pigment Paste | PR1 | PR2 | PR3 | PR4 | CR1 | CR2 |
| surface ¹ | OK | OK | OK | OK | t | t |
| L effect ² | OK | OK | OK | OK | f | f |
| acetone | 10 s | 15 s | 10 s | 10 s | 10 s | 5 s |
| test, 160° C. ³ | | | | | | |
| acetone | 15 s | 25 s | 20 s | 20 s | 10 s | 10 s |
| test, 180° C. ³ | | | | | | |

¹ OK: glossy surface, no craters nor dents
t tolerable (1 to 5 craters or dents per sheet)
u unacceptable (6 to 20 craters or dents per sheet)
² OK no clots of pigment formed
f few clots (between 1 and 5) of pigment per sheet
m many clots (between 6 and 20) of pigment per sheet
³ acetone test: time until the cured paint film could be removed by scratching with a fingernail

The results compiled in table 6 show that the paste resins according to the invention allow higher pigment loading (as measured by the mass fraction of pigments in the paste), and lead to better stabilisation and dispersion of the pigments in the paste and paint.

1. Copolymers ABCDE obtainable by polymerising a monomer mixture comprising mass fractions of
from 10% to 95% of olefinically unsaturated monomers A having at least one urethane group —O—CO—NH—,
from 0% to 50% of basic (meth)acrylic monomers B which comprise at least one tertiary amino group,
from 2.5% to 60% of alkyl(meth)acrylates C, wherein the alkyl residue is linear, branched, or cyclic, and may have from 1 to 20 carbon atoms
from 0% to 20% of olefinically unsaturated compounds D having at least one hydroxyl group in the molecule, preferably hydroxyalkyl(meth)acrylates,
from 0% to 20% of olefinically unsaturated compounds E having none of the functional groups of monomers A and C, and no acid groups.

2. The copolymers ABCDE of claim 1 wherein the mass fraction of B is from 2.5% to 40%.

3. The copolymers ABCDE of claim 1 wherein the mass fraction of D is from 2.5% to 15%.

4. The copolymers ABCDE of claim 1 wherein the mass fraction of E is from 2.5% to 15%.

5. The copolymers ABCDE of claim 1 wherein the olefinically unsaturated monomers A are reaction products of hydroxy functional olefinically unsaturated compounds A1 and isocyanates A2.

6. The copolymers ABCDE of claim 1 wherein the olefinically unsaturated monomers A are reaction products of hydroxy functional olefinically unsaturated compounds A1, isocyanates A2 having more than one isocyanate group per molecule, and compounds A3 which are selected from the group consisting of linear, branched, and cyclic aliphatic alcohols A31 having at least one hydroxyl group and from 2 to 20 carbon atoms, and from compounds A32 having at least one tertiary amino group and at least one further group which is reactive towards isocyanate groups, selected from the group consisting of mercaptan groups, hydroxyl groups, and primary and secondary amino groups.

7. The copolymers ABCDE of claim 1 wherein the monomers B are selected from the group consisting of N,N-dialkylaminoalkyl(meth)acrylates, such as 2-N,N-dimethylaminoethyl acrylate, 3-N,N-dimethylaminopropyl acrylate, 2-N,N-diethyl-aminoethyl acrylate and 3-N,N-diethylaminopropyl acrylate, N-2-acryloyloxyethyl piperidine, N-2-acryloyloxyethyl N′-methyl piperazine and N-2-acryloyloxyethyl morpholine, as well as the corresponding methacrylic compounds.

8. A process for the preparation of the copolymers ABCDE of claim 1 wherein a mixture comprising mass fractions of
from 10% to 95% of olefinically unsaturated monomers A having at least one urethane group —O—CO—NH—,
from 0% to 50% of basic (meth)acrylic monomers B which comprise at least one tertiary amino group,
from 2.5% to 60% of alkyl(meth)acrylates C, wherein the alkyl residue is linear, branched, or cyclic, and may have from 1 to 20 carbon atoms,
from 0% to 20% of olefinically unsaturated compounds D having at least one hydroxyl group in the molecule, preferably hydroxyalkyl(meth)acrylates,
from 0% to 20% of olefinically unsaturated compounds E having none of the functional groups of monomers A and C, and no acid groups,
the quantities of the said compounds A, B, C, D, and E being chosen such that the sum of mass fractions of these equals 100%, are subjected to a radically initiated copolymerisation.

9. The process of claim 8 wherein a further liquid compound F which reacts, under the polymerisation conditions, with at least one of the monomers in an addition reaction, selected from the group consisting of aliphatic lactones, epoxy compounds and such olefinically unsaturated monomers F′ which are only incorporated in a later stage of the polymerisation reaction when more reactive monomers have been consumed.

10. A method of use of the copolymers ABCDE of claim 1 as paste resins, comprising neutralising the copolymers by addition of an acid, under conversion of from 10% to 100% of the basic amino groups of the copolymer to the corresponding ammonium cations, forming an aqueous dispersion by mixing the neutralised copolymer with water, and milling this aqueous dispersion with at least one pigment.
